(19) United States
(12) Patent Application Publication
(10) Pub. No.: US 2015/0180013 A1
(43) Pub. Date: Jun. 25, 2015

(54) HIGH VOLTAGE BATTERY FOR VEHICLES

(71) Applicant: Hyundai Motor Company, Seoul (KR)

(72) Inventors: Seung Ho Ahn, Seoul (KR); Sung Min Choi, Gyeongju (KR); Hong Seok Min, Yongin (KR)

(21) Appl. No.: 14/306,717

(22) Filed: Jun. 17, 2014

(30) Foreign Application Priority Data
Dec. 19, 2013 (KR) 10-2013-0159576

(51) Int. Cl. H01M 2/34; H01M 2/02

(52) U.S. Cl. CPC H01M 2/345; H01M 2/0275; H01M 2220/20

(57) ABSTRACT

A high voltage battery for vehicles is provided and includes an electrode tab that is divided into a first part disposed substantially adjacent to a battery cell and a second part disposed substantially adjacent to a terminal. A first part extension extends from the first part and is fixed to a lower pouch and a second part extension extends from the second part and is fixed to an upper pouch. A conductive polymer layer bonds the first part extension and the second part extension to each other and conducts electricity between the first part extension and the second part extension.

### CROSS-REFERENCE(S) TO RELATED APPLICATION

The present application claims priority of Korean Patent Application Number 10-2013-0159576 filed on Dec. 19, 2013, the entire contents of which is incorporated herein for all purposes by this reference.

### BACKGROUND

1. Field of the Invention

The present invention relates, in general, to a high voltage battery for vehicles which improves safety of a pouch cell using a pouch type circuit interrupt device (CID), thus improving marketability of batteries for vehicles.

2. Description of the Related Art

As the application of a pouch type lithium ion secondary battery has increased in recent years, the energy density of batteries and the energy storage capacity of a unit cell have gradually increased. Particularly, to meet requirements brought from an increase in the mileage of a vehicle, it has been actively studied in recent years to find a technology that can increase the energy storage capacity of a lithium ion secondary battery for vehicles. However, in the conventional pouch type lithium ion secondary battery, the sheath of the battery has a substantially low physical strength and the battery is not provided with a cell level safety device (CID, a positive temperature coefficient switch (PTC), fuse, etc.), and thus, maintaining desired safety of a battery having a substantially high energy storage capacity may be difficult. Particularly, when a vehicle battery is overcharged, gas is generated in the battery and the temperature within the battery increases, thus thermal runaway may be induced in the material within the battery and may result in a fire. Further, when an abnormal reaction is generated in even just one unit cell a vehicle is driven, an abnormal voltage may be easily induced in the battery pack, thereby reducing the driving safety of the vehicle.

The foregoing is intended merely to aid in the understanding of the background of the present invention, and is not intended to mean that the present invention falls within the purview of the related art that is already known to those skilled in the art.

### SUMMARY

Accordingly, the present invention provides a high voltage battery for vehicles, which may maintain safety of a pouch cell using a pouch type CID (Current Interruptive Device, used as an overcharge safety device), to thus improve marketability of batteries for vehicles.

According to one aspect of the present invention, a high voltage battery for vehicles may include: an electrode tab divided into a first part disposed near (e.g., substantially adjacent to) a battery cell and a second part disposed near (e.g., substantially adjacent to) a terminal; a first part extension that extends from the first part and is fixed to a lower pouch; a second part extension that extends from the second part and is fixed to an upper pouch; and a conductive polymer layer that bonds the first part extension and the second part extension to each other and conducts electricity between the first part extension and the second part extension.

The space between the upper pouch and the lower pouch may be vacuumized. Further, when the battery cell expands, the space between the upper pouch and the lower pouch may expand, and the first part extension and the second part extension may be separated from each other. The conductive polymer layer may be formed of at least one selected from the group consisting of polyaniline, polyacetylene, polyphenylene, polythiophene and polypyrrole. The first part extension and the second part extension may be configured as panel-shaped parts that extend from the first part and the second part, respectively, to a side in parallel to each other such that respective ends thereof face each other, wherein the ends of the first and second part extensions may be bonded to each other by the conductive polymer layer. The battery cell, the first part, the second part, the first part extension, the second part extension may be packaged together (e.g., enclosed) by the upper pouch and the lower pouch.

In another aspect, the present invention provides a high voltage battery for vehicles that may include: an electrode tab divided into a first part disposed near (e.g., substantially adjacent to) a terminal and a second part disposed near (e.g., substantially adjacent to) a battery cell; a first part extension that extends from the first part and is fixed to a lower pouch; a second part extension that extends from the second part and is fixed to an upper pouch; and a conductive polymer layer that bonds the first part extension and the second part extension to each other and conducts electricity between the first part extension and the second part extension.

The high voltage battery for vehicles which has the above-mentioned construction is advantageous in that, when the volume of a battery cell is abnormally expanded and a variation in the pressure within the cell is induced, the circuit of the battery may be physically opened at a pressure equal to or greater than a predetermined level, thus interrupting an external electric current and inducing cut-off of the circuit, and thus the present invention may maintain and improve cell level safety and pack voltage safety.

Unlike a conventional pouch type battery, in which, to avoid overcharge, a safety device designed to be limitedly used in the unit of a module or package pack is used, the present invention provides an overcharge safety device that may maintain and improve cell level safety in a unit cell, and may interrupt an abnormal cell reaction in unit cells. Further, the present invention adds an overcharge safety device in a surplus space between a jelly roll and a lead tab inside a pouch type unit cell, thereby improving cell level safety regardless of module type batteries or pack package type batteries.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is an exemplary view illustrating a high voltage battery for vehicles according to an exemplary embodiment of the present invention;

FIG. 2 is an exemplary view illustrating a CID of the high voltage battery for vehicles according to the exemplary embodiment of the present invention; and

FIGS. 3 and 4 are exemplary sectional views illustrating the operation of the high voltage battery for vehicles according to the exemplary embodiment of the present invention.

### DETAILED DESCRIPTION

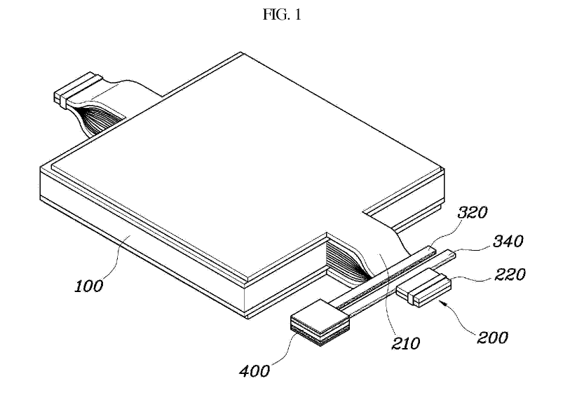

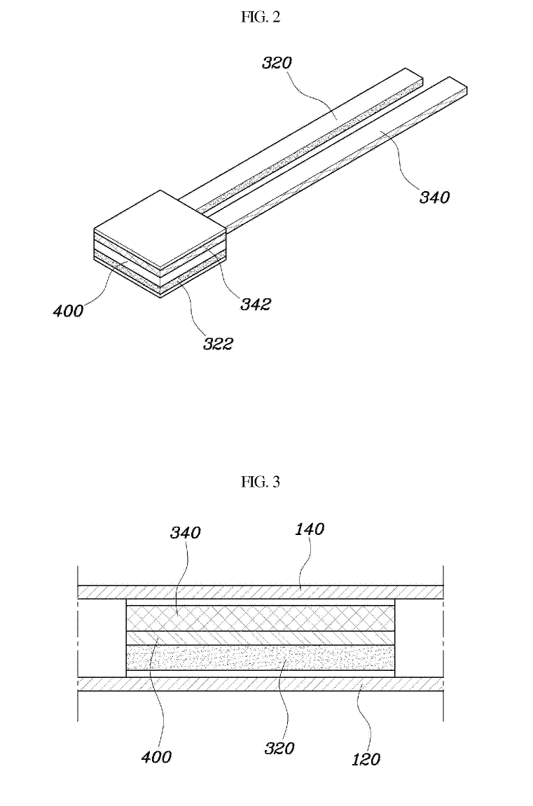

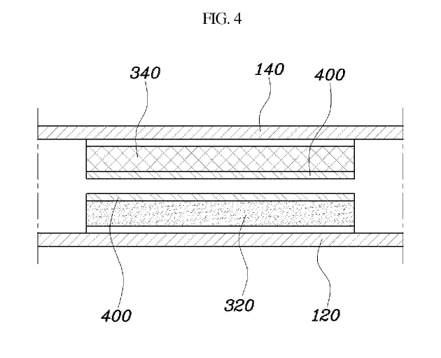

Hereinbelow, exemplary embodiments of the present invention will be described in detail with reference to the accompanying drawings. FIG. 1 is an exemplary view illustrating a high voltage battery for vehicles according to an exemplary embodiment of the present invention. FIG. 2 is an exemplary view illustrating a CID (Current Interruptive Device, used as an overcharge safety device) of the high voltage battery for vehicles according to the exemplary embodiment of the present invention. FIGS. 3 and 4 are exemplary views illustrating the operation of the high voltage battery for vehicles according to the exemplary embodiment of the present invention.

The present invention is provided to improve both the cell level safety of a pouch cell and the driving safety of a vehicle. The high voltage battery for vehicles according to the present invention may include: an electrode tab 200 divided into a first part 210 disposed substantially adjacent to a battery cell and a second part 220 disposed substantially adjacent to a terminal; a first part extension 320 that extends from the first part 210 and is fixed to a lower pouch 120; a second part extension 340 that extends from the second part 220 and is fixed to an upper pouch 140; and a conductive polymer layer 400 that bonds the first part extension 320 and the second part extension 340 to each other and conducts electricity between the first part extension 320 and the second part extension 340.

As shown in FIG. 1, the electrode tab 200 of the present invention may be divided into the first part 210 disposed substantially adjacent to the battery cell and the second part 220 disposed substantially adjacent to the terminal. In a normal state, the first part 210 and the second part 220 may be brought into contact with each other by a CID, allowing the battery to perform normal functions (e.g., when no cell expansion occurs). However, when the battery cell 100 expands, the first part 210 and the second part 220 are separated from each other. In addition, the battery cell 100 of FIG. 1 may be packaged in a pouch that includes an upper pouch 140 and a lower pouch 120, in which the space between the upper pouch 140 and the lower pouch 120 may be vacuumized.

As shown in FIGS. 3 and 4, the electrode tab 200 of the present invention may be divided into the first part 210 disposed substantially adjacent to the battery cell and the second part 220 disposed substantially adjacent to the terminal. The first part extension 320 may extend from the first part 210 and may be fixed to the lower pouch 120 using a bonding agent. The second part extension 340 may extend from the second part 220 and may be fixed to the upper pouch 140 using a bonding agent.

Further, the conductive polymer layer 400 layered between the first part extension 320 and the second part extension 340 may bond the first part extension 320 and the second part extension 340 to each other, and may conduct electricity between the first part extension 320 and the second part extension 340. Thus, in a normal state, electricity may be conducted between the first part 210 and the second part 220, to form a normal battery circuit. However, when the battery cell 100 expands, the first part extension 320 and the second part extension 340 may be separated from each other causing the battery circuit to open.

In particular, when the battery cell 100 expands, the space between the upper pouch 140 and the lower pouch 120 expands, so the first part extension 320 and the second part extension 340 may be separated from each other. In other words, when the battery cell 100 expands, the conductive polymer layer 400 may be melted by a substantially high temperature (e.g., a temperature of a predetermined degree) or the internal resistance of the conductive polymer layer 400 may decrease. When the pressure inside the battery cell 100 increases to greater than a predetermined level, the upper pouch 140 and the lower pouch 120 may expand in opposite directions, and thus, the first part extension 320 and the second part extension 340 may be separated from each other. That is, when the battery cell 100 is overcharged, the conductive polymer layer 400 may be gradually melted by heat and the internal resistance of the conductive polymer layer 400 may increase, and thus the charged current may decrease. Nevertheless, when the battery cell 100 is further overcharged and the upper and lower pouches 140 and 120 are further expanded, the first part extension 320 and the second part extension 340 may be separated from each other by the opposite directional expansion force of the upper and lower pouches 140 and 120 since the conductive polymer layer 400 has melted.

In the present invention, the conductive polymer layer 400 may be formed of at least one selected from the group consisting of: polyaniline, polyacetylene, polyphenylene, polythiophene and polypyrrole. More specifically, the first part extension 320 and the second part extension 340 may be configured as panel-shaped parts that extend from the first part 210 and the second part 220, respectively, to a side of the electrode tab 200 in parallel to each other such that respective ends 322 and 342 of the first and second part extensions 320 and 340 face each other. The respective ends 322 and 342 of the first and second part extensions 320 and 340 may be bonded to each other by the conductive polymer layer 400. Further, the battery cell 100, the first part 210, the second part 220, the first part extension 320, the second part extension 340 may be packaged together by the upper pouch 140 and the lower pouch 120 (e.g., may be enclosed by the pouches). Thus, in a normal state, the first part extension 320 and the second part extension 340 may be maintained in a substantially stably locked state inside the pouch.

In the present invention, the locations of the first part 210 and the second part 220 may be oppositely changed with each other. In other words, in another exemplary embodiment of the present invention, the high voltage battery for vehicles may include: an electrode tab divided into a first part disposed substantially adjacent a terminal and a second part disposed substantially adjacent to a battery cell; a first part extension that extends from the first part and is fixed to a lower pouch; a second part extension that extends from the second part and is fixed to an upper pouch; and a conductive polymer layer that bonds the first part extension and the second part extension to each other and conducts electricity between the first part extension and the second part extension.

The high voltage battery for vehicles which has the above-mentioned construction is advantageous in that, when the volume of a battery cell is abnormally expanded and a variation in the pressure inside the cell is induced, the circuit of the battery may be physically opened at a pressure equal to or greater than a predetermined level, thereby interrupting an external electric current and inducing cut-off of the circuit, so the present invention may improve cell level safety and pack voltage safety.

Unlike a conventional pouch type battery, in which, to avoid overcharge, a safety device designed to be limitedly used in the unit of module or package pack is used, the present invention provides an overcharge safety device that may improve and maintain cell level safety in a unit cell, and may interrupt an abnormal cell reaction in unit cells. Further, the present invention adds an overcharge safety device in a surplus space between a jelly roll and a lead tab inside a pouch type unit cell, thereby improving cell level safety regardless of module type batteries or pack package type batteries.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A battery for vehicles, comprising:
an electrode tab divided into a first part disposed substantially adjacent to a battery cell and a second part disposed substantially adjacent to a terminal;
a first part extension that extends from the first part and is fixed to a lower pouch;
a second part extension that extends from the second part and is fixed to an upper pouch; and
a conductive polymer layer that bonds the first part extension and the second part extension to each other and conducts electricity between the first part extension and the second part extension.

2. The battery for vehicles as set forth in claim 1, wherein a space between the upper pouch and the lower pouch is vacuumized.

3. The battery for vehicles as set forth in claim 1, wherein, when the battery cell expands, a space between the upper pouch and the lower pouch expands, and the first part extension and the second part extension are separated from each other.

4. The battery for vehicles as set forth in claim 1, wherein the conductive polymer layer is formed of at least one selected from the group consisting of: polyaniline, polyacetylene, polyphenylene, polythiophene, and polypyrrole.

5. The battery for vehicles as set forth in claim 1, wherein the first part extension and the second part extension are configured as panel-shaped parts that extend from the first part and the second part, respectively, to a side of the electrode tab in parallel to each other causing respective ends thereof to face each other, wherein ends of the first and second part extensions are bonded to each other by the conductive polymer layer.

6. The battery for vehicles as set forth in claim 1, wherein the battery cell, the first part, the second part, the first part extension, the second part extension are packaged together by the upper pouch and the lower pouch.

7. A battery for vehicles, comprising:
an electrode tab divided into a first part disposed substantially adjacent to a terminal and a second part disposed substantially adjacent to a battery cell;
a first part extension that extends from the first part and is fixed to a lower pouch;
a second part extension that extends from the second part and is fixed to an upper pouch; and
a conductive polymer layer that bonds the first part extension and the second part extension to each other and conducts electricity between the first part extension and the second part extension.

8. The battery for vehicles as set forth in claim 7, wherein a space between the upper pouch and the lower pouch is vacuumized.

9. The battery for vehicles as set forth in claim 7, wherein, when the battery cell expands, a space between the upper pouch and the lower pouch expands, and the first part extension and the second part extension are separated from each other.

10. The battery for vehicles as set forth in claim 7, wherein the conductive polymer layer is formed of at least one selected from the group consisting of: polyaniline, polyacetylene, polyphenylene, polythiophene, and polypyrrole.

11. The battery for vehicles as set forth in claim 7, wherein the first part extension and the second part extension are configured as panel-shaped parts that extend from the first part and the second part, respectively, to a side of the electrode tab in parallel to each other causing respective ends thereof to face each other, wherein ends of the first and second part extensions are bonded to each other by the conductive polymer layer.

12. The battery for vehicles as set forth in claim 7, wherein the battery cell, the first part, the second part, the first part extension, the second part extension are packaged together by the upper pouch and the lower pouch.
